(19) United States
(12) Patent Application Publication
(10) Pub. No.: US 2015/0379524 A1
(43) Pub. Date: Dec. 31, 2015

(54) METHOD AND SYSTEM FOR AUTHENTICATING PHYSICAL ITEMS

(71) Applicant: Kezzler AS, Oslo (NO)

(72) Inventor: Magnar Løken, Oslo (NO)

(21) Appl. No.: 14/314,708

(22) Filed: Jun. 25, 2014

(51) Int. Cl. G06Q 30/00

(52) U.S. Cl. CPC G06Q 30/0185

(57) ABSTRACT

A method and system for authenticating physical items includes: creating a group of safe codes, wherein each safe code includes a system code and a random key, said system code includes first and second level references wherein said second level reference is unique within said first level reference, storing said random key in said track and trace system in a storage location of a data store identified by said first and second level references, creating a group of marking codes by obfuscating each of said safe codes using an obfuscation key to obtain an obfuscated code and combining said obfuscated code with an obfuscation key id corresponding to said obfuscation key, and marking at least some of said marking codes on said physical items.

### FIELD OF THE INVENTION

The present invention relates to authentication of physical items in a supply chain. More specifically it relates to a method and system for authentication or track and trace of marked physical items using unique, random keys for marking on the items, and how to later authenticate the items based on the random keys.

### BACKGROUND ART

Track and Trace systems for tracking and tracing of manufactured items is well known in the industry. Counterfeiting affects both the manufacturer and the public. E.g. in the field of pharmaceuticals, fake medicines may have no effect, or they can have dangerous side effects.

The systems used for preventing counterfeiting are implemented in a number of different ways.

One group of technology in the field is concerned with how to mark items and how to read back the information from the items to avoid copying of products. To avoid copying, the items can be marked with invisible markers, encrypted codes, RFID tags etc. It should be difficult for a counterfeiter to discover and decipher the information marked on the item, since this would enable the counterfeiter to copy the items and the marking in a way that would lead a consumer to believe they buy the original product.

Another group of technology is more concerned with how to follow, or trace an item from the manufacture to the end customer. By controlling the supply chain, and especially what happens to the items when being received and shipped in the distribution points, the possibility of successful counterfeiting or other fraudulent activities is reduced. This is commonly referred to as secure track and trace.

A secure track and trace system is surveying and managing all goods having been marked and registered with a unique identifier, and at the same time controlling all parties allowed to handle the products, all the way from the manufacture to the end consumer.

Track and trace systems according to background art works in the way that product items and associated transportation units are marked with a unique identifier. This identifier is then utilized to continuously authenticate the product in the supply chain. If the authentication process has a positive outcome, i.e. the product and code has been determined to be genuine, additional information related to the product and the present stage of the supply chain may be recorded and stored for later retrieval and analysis. The pivotal information that is recorded during the addition of a new tracking record is the identity of the product or transportation unit, the location and the time and also information about the operator. If available, the devices and method by which the product was authenticated, as well as other circumstantial and pertinent information may also be recorded in the tracking record.

This series of tracking records recorded by the track and trace system will result in a complete history of the handling of the product in the supply chain, that might be presented and audited at any time for security or other purposes.

The two groups of technologies described above are often combined to ensure maximum control of the supply chain and the end users confidence in the purchased goods.

European patent publication EP2104067A1 describes a method and apparatus for identifying, authenticating, tracking and tracing manufactured items in containers, where each container is suitable for containing one or more units.

US patent application 2011/0154046A1 describes a method and apparatus for storage of data for a batch of manufactured items. Each item is marked with a unique identifier from a set of unique identifiers within a pre-defined range. The number of unique identifiers is larger than the number of manufactured items, and some of the unique identifiers within the range will not be used. The unused identifiers are identified.

US patent application 2012/0130868A1 discloses a system and a method for efficient storage of track and trace data that is being created during tracking and tracing items, comprising generating a group of unique codes, wherein each code is a unique encrypted reference, transferring the unique codes to an item marking location and marking the items. An item can be tracked by transferring the code marked on the item to the track and trace system where it is decrypted, and based on the unique code, creating a tracking record in a unique storage location, where the unique reference refers to the unique storage location. A tree structure resembling the packaging hierarchy is disclosed, where the nodes in the tree are referenced by the unique code.

Most track and trace systems use tracking records in a database to store information about the items in the supply chain as described above. However, one of the problems with databases is that for very large numbers of items the performance needed to provide an acceptable level of system response time has found to be too unpredictable as well as inadequate, since an index for the large amounts of data has to be managed. For the handling of large-amounts of re-packaged items, this problem increases.

A problem remaining with background art technology is that it may be possible to tamper the codes marked on the physical items, and in this way be able to authenticate products that do not belong in the supply chain.

### SHORT SUMMARY OF THE INVENTION

A main object of the present invention is to disclose a system and method for authentication of marked items, where the problems of prior art as defined above have been solved. It has also been an object to use the same authentication method for tracking and tracing of items.

In order to achieve the above, the present invention provides a method for authenticating physical items comprising the steps of;
creating a first group of safe codes in a computer implemented system, wherein each safe code comprises a system code and a random key, wherein said system code comprises a first level reference and a second level reference, and wherein said second level reference is unique within said first level reference,
storing said random key in said track and trace system in a storage location of a data store where the storage location is identified by said first level reference and said second level reference,
creating a group of marking codes by obfuscating each of said safe codes in said first group in a obfuscator function using an obfuscation key to obtain an obfuscated code and combining said obfuscated code with an obfuscation key id corresponding to said obfuscation key,
transferring said group of marking codes to an item marking location ,
marking at least some of said marking codes on said physical items to obtain marked physical items.

The invention also provides a corresponding computer implemented physical item authentication system.

### Advantages:

### Absolutely Safe

An important advantage of the present invention over prior art is that the marking codes generated for marking on the physical items, such as boxes, etc. are absolutely safe due to the random key that is integrated and mixed into the resulting marking code.

Another advantage, is that as the huge number of open and marked codes in the supply chain or even potentially other more available sources of codes compromised by printers, etc, is that with the current innovation, such open codes cannot be a useful source or information for counterfeiters that can use it as a basis to re-engineer the algorithms, or their keys, for generating “genuine” codes, since one time pad encryption is the only encryption method that is theoretically 100% impossible to crack. All other encryption methods resistance to cracking is a matter of resources and computer capacity, and in theory they can all be cracked with the sufficient resources available.

### Takes Longer Time to Produce, but can be Stored for Use.

Further, marking codes can be generated beforehand, without any relation to the product they are to be marked on later. In relation to this, not all marking codes transferred to the marking location have to be used, and they can be marked in any sequence on the physical items.

The additional security resulting from the code generation process according to the invention may require some more time since random codes have to be generated and introduced as part of the code. However, this has no practical impact, since the codes according to the invention can be generated long time before marking.

### No Need for Index

Most track and trace systems use tracking records in a database to store information about the items in the supply chain as described above. However, one of the problems with databases is that for very large numbers of items the performance needed to provide an acceptable level of system response time has found to be too unpredictable as well as inadequate, since an index for the large amounts of data has to be managed.

The system and method according to the invention does not require a database index, and the effect is that new entries in the system, as well as look-up of existing entries for authentication or track and tracing purposes becomes faster and more efficient. Due to the light data structure, real systems may operate with all relevant data for millions of marked items in random access memory, RAM.

### Disclaimer

It is to be understood that both the foregoing general description and the following detailed description are exemplary, and are intended to provide further explanation of the invention as claimed. Other advantages and features of the invention will be apparent from the following description, drawings and claims.

### FIGURE CAPTIONS

The features of the invention are set forth with particularity in the appended claims. The invention itself, however, may be best understood by reference to the following detailed description of the invention, which describes an exemplary embodiment of the invention, taken in conjunction with the accompanying drawings, in which:

FIG. 1 illustrates schematically generation of groups (300) of marking codes (301) and marking the marking codes (301) on physical items (350).

FIG. 2 illustrates authentication of a physical item (350) marked with a marking code (301).

FIG. 3 illustrates tracking of a physical item (350) marked with a marking code (301).

### EMBODIMENTS OF THE INVENTION

### Code Generation

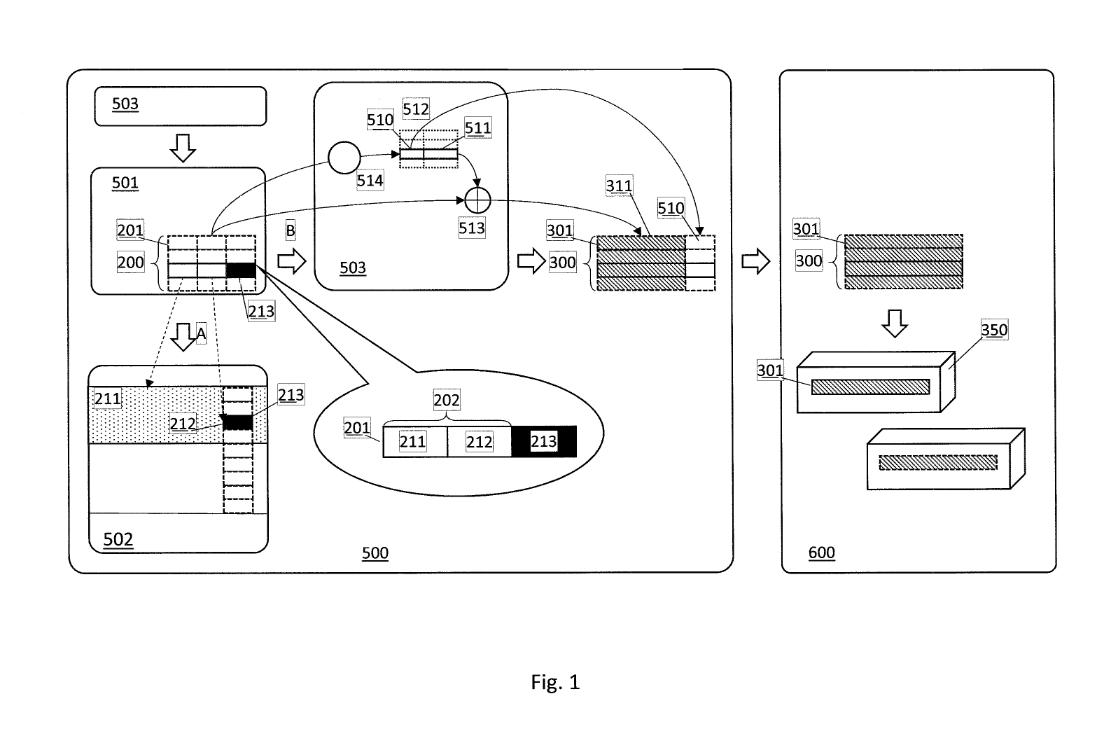

FIG. 1 illustrates schematically an embodiment of the method according to the invention, where marking codes (301) are generated in groups (300) in a authentication or track and trace system (500), the groups of marking codes (300) is transferred to a marking location (600) where the physical items (350) are marked with the marking codes (301).

The actual code generation is a key element in obtaining the advantageous effects of the invention which will become apparent when the physical items (350) are subject to authentication, tracking and tracing, as will be described below.

In a code generator (501) a first group of codes (200) with n safe codes (201) is created. The number of codes in the first group (200) can be based on a request from a manufacturing process comprising a certain number of produced articles to be marked, typically a production batch. However, there is no requirement that the all the marking codes (301) transferred to a marking location are used, neither that they are marked sequentially on the articles.

Each safe code (201) in a first group (200) comprises a system code (202) and a random key (203), as illustrated in an enlarged portion of the drawing. The system code (200) comprises a first level reference (211) and a second level reference (212), wherein the second level reference (212) is unique within the first level reference (211). The first and second level references (211, 212) are typically numerals, but can also be any type of characters or digits.

The first level reference may be a number associated with the production batch, or a unique order number. It should be observed that the generated codes do not in any way have to be related to the real articles or the batch at the time of generation. The first level reference (211) may also be seen as an identifier for the first group (200).

The second level reference (212) may typically be a sequential number generated by the code generator (501). This number is unique within the first level reference (211), but may be re-used in another group (200).

The random key (213) is a sequence of characters or digits that is completely random. The code generator (501) can be responsible for generating the keys, or they may be generated in a separate random generator (503) and be imported in batches. For the integrity of the system, it is essential that the keys (213) are completely random and not available to other parties.

When all the safe codes (201) have been generated, the first group (201) now contains a system code (200) paired with a random key (213). Such a random key collection is also sometimes referred to as a one time pad. The safety and security of the safe codes (201) is absolute, since it follows from the random key (213) which is theoretically 100% safe and cannot be deducted or otherwise calculated. A random code is by definition not any kind of checksum, or otherwise a result or outcome of an algorithm, or result or outcome from any algorithm that is manipulating information/data as its input from other parts of the construction of the safe codes, or any information related to these.

After code generation, there are two additional steps denoted by the arrows A and B in FIG. 1, which are basically independent of each other taking place in the authentication or track and trace system (500).

### Storing Pad

In step A, the random key (213) is stored in a data store (502), where the storage location (520) of the random key (213) in the data store (502) is determined by the value of the first and second level references (211, 212). The first level reference (211) points to an identifiable and further defined area, shown as a dotted area in FIG. 1, of the data store (502), while the second level reference points to an identifiable sub-area within the first area.

In one embodiment each area pointed to by the first level reference (211) is a separate file in a file system, while the second level reference (212) is a specific line within the file. In another embodiment the first level reference (211) is a segment in a memory space, while the second level reference (212) is a specific address within the memory space. The size and location of the actual areas pointed to may be static or dynamic, where the mapping between the physical storage location address and the first and second level references (211, 212) is maintained by the authentication or track and trace system (500) or an underlying mapping layer. For the invention it important that the first and second level references (211, 212) always point to a storage location (520) where the random key (213) is stored, however, the actual implementation can be performed in a number of ways by a person skilled in the art.

### Obfuscation

In step B, which is basically independent of step A, each of the safe codes (201) in the first group (200) are obfuscated in an obfuscator (503) to obtain obfuscated codes (311).

However, in a preferred and safer obfuscation method is illustrated in FIG. 1, An obfuscator key (511) is associated with the obfuscator key id (510). The safe code (201) is then obfuscated with the obfuscated key (511) in an obfuscator function (513), where the result is an obfuscated code (311).

Then the obfuscated code (311) and the corresponding obfuscation key id (510) are combined, e.g. the obfuscation key id (510) is appended to the obfuscated code (311) to obtain the marking code (301).

The obfuscation key and key id pairs can be stored e.g. in a key table (512) of the system (500).

Many types of obfuscator functions (513) or cryptographic functions are possible. In a preferred embodiment an exclusive disjunction operation, XOR is used. The XOR function has the benefit that the encrypted or obfuscated code (311) can later be de-crypted or de-obfuscated by applying the same XOR function once more.

Note that the obfuscated code (311), or any of its components, is not a checksum. The purpose is to create a random and unpredictable code that can later be used to authenticate the marked item and serve as a pointer to item specific information stored in the authentication or track and trace system (500). Thus it is not used for security, as such, which is provided by the random key (213).

At the end of the this step the first group (200) of safe codes (201) have now become a marking group (300) of marking codes (301), wherein each marking code (301) comprises an obfuscated code (311) and an obfuscation key id (511).

### Hashing to Obtain Obfuscation Key Id

In an embodiment the obfuscator key id (510) is obtained by hashing the safe code (201) in a hasher (514), i.e. a one way encryption function, as illustrated in FIG. 1.

In an embodiment the obfuscator key id (510) contains only a portion of the code resulting from the obfuscation. If hashing is used, the hash value is usually longer than what is needed to be a obfuscator key id (510). It is not important which part of the hash is used, and a fixed count from left to right or opposite may be used.

The key table (512) may have been prepared or generated before code generation starts, and a substring of the hash of the safe code (201) will then match an already existing obfuscator key id (510). To make sure that the hash value will always match a obfuscator key id (510) value in the key table (512), the modulus operation of the safe code (201) can be performed, e.g.; h=a mod m, where h is the hash value, a is the safe code (201) and m is the number of rows in the key table (512). In this case the obfuscator key id (510) may therefore an integer from 1 to m. The obfuscator key id (510) may of course also be constituted by any symbols other than integers. The number of symbols s in the symbol set, e.g. 21 characters, and the allowable number of positions p or characters for the obfuscator key id (510), e.g. 3, will determine the number m; m=s^{p}=21³=9261.

In an embodiment the same obfuscation key (511) is used for all safe codes (201) of a group (200).

### Marking Location

The marking group (300) is then transferred to the marking location (600), where the marking codes (301) are marked on the physical items (350). After the marking group (300) leaves the authentication or track and trace system (500) the marking codes (301) are seen as integral codes, and the combination of the obfuscated code (311) and the obfuscation key id (511) is preferably not visible. In FIG. 1 each of the marking codes (301) in the marking location (600) are therefore indicated as one whole. To ease later de-obfuscation, the method used for combining the obfuscated code (311) and the obfuscation key id (511) is in an embodiment always the same.

The physical package (350) is now ready for entering the supply chain for distribution to an end location.

It should be noted that after the transferal of the generated marking codes (301) from the system (500) to the marking location (600), neither the safe codes (201) nor the marking codes (301) are stored in the system (500). The only traces left in the system (500) from the code generation process is the random key (213) stored in a storage location in a data store corresponding to the two level system code (202) and the key table (512).

### Method Claim

In an embodiment the method for authenticating physical items (350) therefore comprises the steps of;
creating a first group (200) of safe codes (201) in a computer implemented system (500), wherein each safe code (201) comprises a system code (202) and a random key (203), wherein said system code (202) comprises a first level reference (211) and a second level reference (212), and wherein said second level reference (212) is unique within said first level reference (211),
storing said random key (213) in said track and trace system (500) in a storage location of a data store (502) where said storage location is identified by said first level reference (211) and said second level reference (212),
creating a group (300) of marking codes (301) by obfuscating each of said safe codes (201) in said first group (200) in a obfuscator function (513) using an obfuscation key (511) to obtain an obfuscated code (311) and combining said obfuscated code (311) with an obfuscation key id (510) corresponding to said obfuscation key (511),
transferring said group (300) of marking codes (301) to an item marking location (600),
marking at least some of said marking codes (301) on said physical items (350) to obtain marked physical items.

### System Claim

In an embodiment the invention is a computer implemented physical item authentication system (500) comprising;
a random generator (503) arranged for generating random keys (203),
a code generator (501) arranged for creating a first group (200) of safe codes (201), wherein each safe code (201) comprises a system code (202) and one of said random key (203), wherein said system code (202) comprises a first level reference (211) and a second level reference (212), and wherein said second level reference (212) is unique within said first level reference (211),
a data store (502) with storage locations uniquely identified by a two level reference, wherein said authentication system (500) is arranged for storing said one of said random keys (213) in a storage location identified by said first level reference (211) and said second level reference (212), and
an obfuscator (503) arranged for creating a group (300) of marking codes (301) by obfuscating each of said safe codes (201) in said first group (200) in a obfuscator function (513) using an obfuscation key (511) to obtain an obfuscated code (311) and combining said obfuscated code (311) with an obfuscation key id (510) corresponding to said obfuscation key (511).

### Authentication

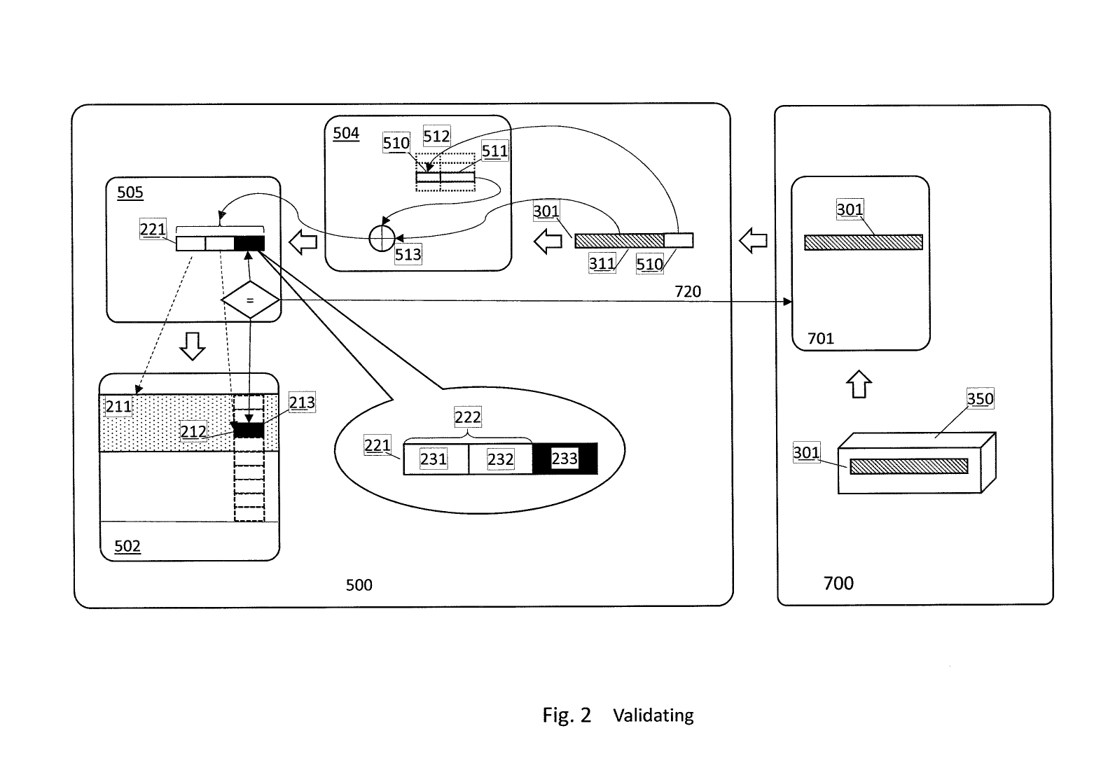

The effect of the code generation method according to the invention described above will become clearer by examining how the marked physical item (350) can be authenticated from an authentication location (700) in the supply chain as shown in FIG. 2.

First the marking code (301) on the physical package (350) is scanned or entered into the authentication device (701). The authentication device may be a computer with a web browser opening an authentication page of a web server of the authentication or track and trace system (500), or any other device capable of communicating with the system (500).

As soon as the marking code (301) enters the system (500), the marking code will be split into the obfuscated code (311) and the obfuscation key id (510) based on the reversal of the method used when combining these two data fields when the marking code (301) was generated.

Based on the obfuscation key id (510), the obfuscation key (511) is looked up, in e.g. the key table (512) and the obfuscated code (301) is de-obfuscated in the obfuscator function (513) of the obfuscator (503) to obtain an incoming code (221). The incoming code (221) is similar in format to the safe code (201) generated initially, as explained above.

The validator (505) will then look up the random key (213) stored in a storage location in the data store (502) uniquely identified by the first and second incoming references (231, 232) corresponding to a pair of first and second level references (211, 212) in the data store (502) pointing to the stored random key (213). The validator compares the incoming random key (233) with the stored random key (213), and if they are equal, a positive validation message (720) is sent back to the authentication device (701) in the authentication location (700). If the keys are not equal, a negative validation message can be sent.

In addition to the validation based on the incoming random key (233), other types of validation can be performed initially:
Split into the obfuscated code (311) and the obfuscation key id (511) not possible.
Obfuscation key id (511) not found.
Incoming first or second level references (231, 232) not corresponding to any stored first and second level references (211, 212).

In all these cases the incoming marking code (301) cannot be authenticated, since it is probably false or generated in another system, and a negative validation message (720) is sent back to the authentication device (701) in the authentication location (700).

### Method—Authentication

In an embodiment the method therefore comprises the steps of;
transferring one of said marked physical items (350) to an authentication location (700),
transferring said marking code (301) marked on said physical item (350) to said system (500),
splitting said marked code (301) into an obfuscated code (311) part and an obfuscation key id (510) part,
de-obfuscating said obfuscated code (311) part in said obfuscator function (513) with an obfuscation key (511) identified by said obfuscation key id (510) part to obtain an incoming safe code (221) comprising an incoming system code (222) and an incoming random key (233),
looking up a random key (213) in a storage location of said data store (502) identified by an incoming first level reference (231) and an incoming second level reference (232) of said incoming system code (221),
authenticating said physical item (350) if said incoming random key (233) is similar to said stored random key (213).

### System Authentication

In an embodiment the invention the corresponding system (500) is arranged for receiving a marking code (301) from an authentication location (700), wherein said obfuscator (503) is arranged for;
splitting said marked code (301) into an obfuscated code (311) part and an obfuscation key id (510) part, and
de-obfuscating said obfuscated code (311) part in said obfuscator function (513) with an obfuscation key (511) identified by said obfuscation key id (510) part to obtain an incoming safe code (221) comprising an incoming system code (222) and an incoming random key (233), wherein said system further comprising a validator (505) arranged for;
looking up a random key (213) in a storage location of said data store (502) identified by an incoming first level reference (231) and an incoming second level reference (232) of said incoming system code (221),
authenticating said physical item (350) if said incoming random key (233) is similar to said stored random key (213).

### Tracking

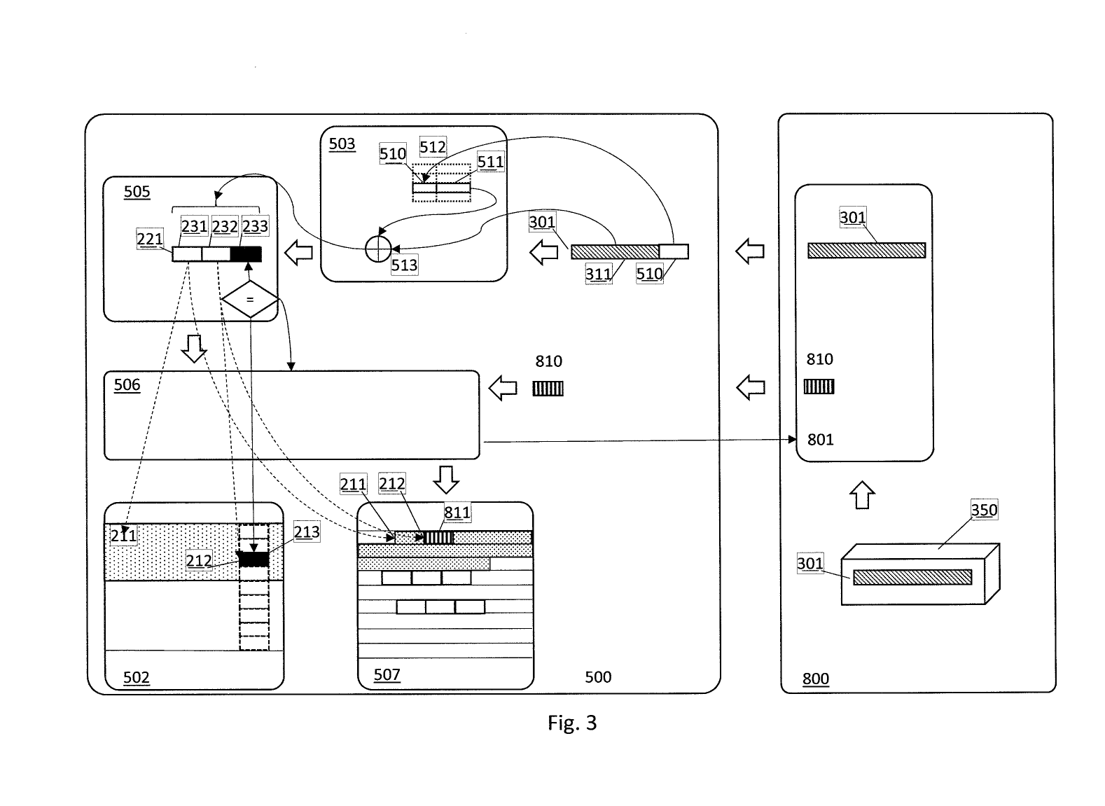

In an embodiment the invention is also method and system for tracking the marked physical item (350). In this case the physical item (350) has arrived in a tracking location (800) as illustrated in FIG. 3.

First the marking code (301) on the physical package (350) is scanned or entered into the tracking device (801). The tracking device may be a computer with a web browser opening a tracking page of a web server of the track and trace system (500), or any other device capable of communicating with the system (500). Further, tracking information (810) is sent from the tracking location (801) to the track and trace system (500) together with the scanned marking code (301), or later as part of a pre-defined protocol for information exchange between the tracking device (801) and the track and trace system (500).

Preferably the tracking device (801) is connected to, and arranged to send tracking information (801) automatically to the track and trace system (500) as soon as the marking code (301) of a physical item (350) has been scanned.

When the track and trace system (500) is handling the information received, e.g. the marking code (301) and the tracking information (810), it will first authenticate the marking code (301) as described above.

If the marking code (310) can be authenticated, the tracker (506) will analyze the tracking information (810) and store a tracking record (811) in a tracking storage (507) of the tracking and tracing system (500). The tracking record (811) is stored in a location of the tracking storage (507) that is identified by the first and second level references (211, 212).

In other tracking locations (800) along the supply chain, new tracking information (810) will be sent to the track and trace system (500), and new tracking records will be added in the same tracking storage (507). If the physical item (350) has been tracked before, and a tracking record (811) already exists, the new tracking record (811) will be added together with the previous tracking record (811).

The actual tracking content of the tracking record (811) is not part of this invention, and it can be found in background art. However, essential tracking information is where, when, what and by whom the physical item was tracked.

The tracker may send an acknowledgement (820) to the tracking device (801) to indicate that the tracking was successful or unsuccessful.

### Method—Tracking

In an embodiment the method therefore comprises the step of;
transferring tracking information (800) to said system (500),
analyzing said tracking information (800) and create a corresponding tracking record;
storing said tracking record (811) in a tracking storage (507) of said system (500), wherein said tracking record (811) is stored in a location of said tracking storage (507) uniquely identified by said first and second level references (211, 212).

### System—Tracking

In an embodiment the corresponding system comprises;
a tracker (506) arranged for receiving tracking information (800) from a tracking location (800), and analyzing said tracking information (800) and create a corresponding tracking record, and
a tracking storage (507) with storage locations uniquely identified by a two level reference, wherein said tracker is arranged for storing said tracking record (811) in in a location of said tracking storage (507) uniquely identified by said first and second level references (211, 212).

### Tracing

Tracing is the process of requesting information about specific physical items (350) marked with marking codes (301) that has entered the supply chain.

In an embodiment of the invention, a copy of the marking codes (301) used to mark the physical items (350) during the initial marking process in the marking location (600), have been stored in the marking location (600), or any suitable location by e.g. the manufacturer. If the manufacturer later on requests a trace of a specific item, the marking code (301) of that item is sent to the track and trace system (500) and authenticated as explained above. If the code is authenticated, a tracing module (not shown) will retrieve the tracking records from the tracking storage (507) at the location given by the first and second references (211, 212). The tracking records (811) for the specific physical item (811) can then be returned to the manufacturer. They may also be analyzed by the track and trace system (500) before the result is presented.

In an embodiment the first reference (211) is directly related to the batch number of a production or marking process. All the marked physical items (350) from the batch can therefore be traced in a single operation by entering the batch number only. Since the first reference (211) defines a storage location comprising all tracking information for the comprising elements, this kind of lookup becomes simpler and faster than for prior art systems.

1^{st}, 2^{nd} Reference of Marking Code

In an embodiment the obfuscated code (311) and the obfuscation key id (510) are combined with the first and second references (211, 212) to obtain the marking code (301) (not shown). This enables quick lookup in the data store (502) and/or the tracking store (507) of a specific marked item (350) based on the first and second references (211,212), and enables parallel processing of the authentication process and tracking or tracing process. A first quick validation can also be performed by analyzing the clear, incoming first and second references (241, 242), to see if they match existing first and second references (211, 212) in the authentication or track and trace system (500).

### Flat Files

In an embodiment the data store (502), and/or the tracking storage (507) is one or more flat files in a files system of the system (500). An example of an addressing scheme that can be used, is to have a main file addressed by the first level reference (211), wherein the first file comprises a list of the second level references (212), and a pointer or path to a secondary file for each of the second level references (212). The secondary file could then contain more detailed information about the corresponding marked item (301), such as tracking records, status etc.

1. A method for authenticating physical items comprising the steps of:
creating a first group of safe codes in a computer implemented system, wherein each safe code comprises a system code and a random key, wherein said system code comprises a first level reference and a second level reference, and wherein said second level reference is unique within said first level reference;
storing said random key in said track and trace system in a storage location of a data store where said storage location is identified by said first level reference and said second level reference;
creating a group of marking codes by obfuscating each of said safe codes in said first group in a obfuscator function using an obfuscation key to obtain an obfuscated code and combining said obfuscated code with an obfuscation key id corresponding to said obfuscation key;
transferring said group of marking codes to an item marking location; and
marking at least some of said marking codes on said physical items to obtain marked physical items.

2. The method for authenticating physical items according to claim 1, comprising the steps of:
transferring one of said marked physical items to an authentication location;
transferring said marking code marked on said physical item to said system;
splitting said marked code into an obfuscated code part and an obfuscation key id part;
de-obfuscating said obfuscated code part in said obfuscator function with an obfuscation key identified by said obfuscation key id part to obtain an incoming safe code comprising an incoming system code and an incoming random key;
looking up a random key in a storage location of said data store identified by an incoming first level reference and an incoming second level reference of said incoming system code;
authenticating said physical item if said incoming random key is similar to said stored random key.

3. The method for authenticating physical items according to claim 1, wherein said obfuscation key is the same for all said marking codes of said group.

4. The method for authenticating physical items according to claim 2, further comprising said steps of:
transferring tracking information to said system;
analyzing said tracking information and creating a corresponding tracking record; and
storing said tracking record in a tracking storage of said system, wherein said tracking record is stored in a location of said tracking storage uniquely identified by said first and second level references.

5. The method for authenticating physical items according to claim 1, wherein said obfuscator function is an exclusive disjunction operation, XOR.

6. A computer implemented physical item authentication system comprising:
a random generator arranged for generating random keys;
a code generator arranged for creating a first group of safe codes, wherein each safe code comprises a system code and one of said random key, wherein said system code comprises a first level reference and a second level reference, and wherein said second level reference is unique within said first level reference;
a data store with storage locations uniquely identified by a two level reference, wherein said authentication system is arranged for storing said one of said random keys in a storage location identified by said first level reference and said second level reference;
an obfuscator arranged for creating a group of marking codes by obfuscating each of said safe codes in said first group in a obfuscator function using an obfuscation key to obtain an obfuscated code and combining said obfuscated code with an obfuscation key id corresponding to said obfuscation key.

7. The computer implemented physical item authentication system according to claim 6, arranged for receiving a marking code from an authentication location, wherein said obfuscator is arranged for:
splitting said marked code into an obfuscated code part and an obfuscation key id part; and
de-obfuscating said obfuscated code part in said obfuscator function with an obfuscation key identified by said obfuscation key id part to obtain an incoming safe code comprising an incoming system code and an incoming random key,
wherein said system further comprises a validator arranged for:
looking up a random key in a storage location of said data store identified by an incoming first level reference and an incoming second level reference of said incoming system code; and
authenticating said physical item if said incoming random key is similar to said stored random key.

8. The computer implemented physical item authentication system according to claim 7, further comprising:
a tracker arranged for receiving tracking information from a tracking location, and analyzing said tracking information and create a corresponding tracking record; and
a tracking storage with storage locations uniquely identified by a two level reference, wherein said tracker is arranged for storing said tracking record in in a location of said tracking storage uniquely identified by said first and second level references.

9. The computer implemented physical item authentication system according to claim 6, wherein said data store is one or more flat files.

10. The computer implemented physical item authentication system according to claim 8, wherein said tracking storage is one or more flat files.

11. The computer implemented physical item authentication system according to claim 6, wherein said data store is a Random Access Memory (RAM).

12. The method for authenticating physical items according to claim 2, wherein said obfuscation key is the same for all said marking codes of said group.
